(19) United States
(12) Patent Application Publication
(10) Pub. No.: US 2012/0066364 A1
(43) Pub. Date: Mar. 15, 2012

(54) INFORMATION PROCESSING APPARATUS, INFORMATION PROCESSING METHOD, PROGRAM, AND INFORMATION PROCESSING SYSTEM

(75) Inventor: Hidehiko OKUNO, Tokyo (JP)

(73) Assignee: Sony Corporation, Tokyo (JP)

(21) Appl. No.: 13/225,978

(22) Filed: Sep. 6, 2011

(30) Foreign Application Priority Data
Sep. 13, 2010 (JP) 2010-204701

(51) Int. Cl. G06F 15/173

(52) U.S. Cl. 709/223

(57) ABSTRACT

An information processing apparatus includes: a connection unit connecting an external apparatus to the information processing apparatus; a control request receiving unit receiving, from a controller, a control request for remotely controlling the external apparatus by network communication; and a change request transmitting unit transmitting, to the external apparatus, a change request so that the external apparatus is able to be remotely controlled, when the control request receiving unit receives the control request and the external apparatus is not able to be remotely controlled.

### BACKGROUND

The present disclosure relates to an information processing apparatus, an information processing method, a program, and an information processing system.

In recent years, when an operation mode of an external apparatus connected to a server is changed in the server to which the external apparatus can be connected, the operation mode of the external apparatus is changed by, for example, a key operation of an input unit of the server by a user. As the external apparatus, a portable content reproduction apparatus can be exemplified. As the operation mode of the external apparatus, a remote control disabled mode and a remote control enabled mode can be exemplified. As the server, a DMS (Digital Media Server) of a DLNA (Digital Living Network Alliance) can be exemplified.

When the operation mode of the external apparatus connected to the server is changed in the above-described server, the operation mode of the external apparatus is changed by a request, which is transmitted by IR communication executed by, for example, a key operation of the input unit of an auxiliary IR remote controller by a user, for changing the operation mode of the external apparatus. For example, Japanese Unexamined Patent Application Publication No. 2010-010886 discloses a technique for the IR communication.

### SUMMARY

However, a communicable range becomes restricted in the IR communication. For this reason, a problem may arise in that a user is not able to remotely control an external apparatus connected to the above-described server within a predetermined range in which the IR communication can be executed.

It is desirable to provide an information processing apparatus, an information processing method, a program, and an information processing system which are novel and improved and in which an external apparatus can remotely be controlled out of a predetermined range by a user.

According to an embodiment of the disclosure, there is provided an information processing apparatus including: a connection unit connecting an external apparatus to the information processing apparatus; a control request receiving unit receiving, from a controller, a control request for remotely controlling the external apparatus by network communication; and a change request transmitting unit transmitting, to the external apparatus, a change request so that the external apparatus is able to be remotely controlled, when the control request receiving unit receives the control request and the external apparatus is not able to be remotely controlled.

The information processing apparatus may further include a DB information request transmitting unit transmitting, to the external apparatus, a DB information request for acquiring DB information of the external apparatus, when the control request receiving unit receives the control request and the external apparatus is able to be remotely controlled or when the change request transmitting unit transmits the change request to the external apparatus and the external apparatus is consequently able to be remotely controlled; a DB information receiving unit receiving the DB information of the external apparatus transmitted from the external apparatus as a result obtained when the DB information request transmitting unit transmits the DB information request to the external apparatus; and a DB information transmitting unit transmitting, to the controller, the DB information of the external apparatus received by the DB information receiving unit by network communication.

The information processing apparatus may further include a DB information storage unit storing the DB information of the external apparatus received by the DB information receiving unit.

The DB information transmitting unit may transmit, to the controller, meta information in the DB information of the external apparatus received by the DB information receiving unit by the network communication.

When the control request receiving unit receives the control request and the external apparatus is able to be remotely controlled or when the change request transmitting unit transmits the change request to the external apparatus and the external apparatus is consequently able to be remotely controlled, the DB information request transmitting unit may transmit, to the external apparatus, DB information request for acquiring the meta information in the DB information of the external apparatus. The DB information receiving unit may receive the meta information, which is transmitted from the external apparatus, in the DB information of the external apparatus as a result obtained when the DB information request transmitting unit transmits the DB information request to the external apparatus. The DB information transmitting unit may transmit the meta information, which is received by the DB information receiving unit, in the DB information of the external apparatus to the controller by the network communication.

The information processing apparatus may further include a DB information storage unit storing the meta information, which is received by the DB information receiving unit, in the DB information of the external apparatus.

The control request may be a control request for changing an operation mode of the external apparatus to a remote control enabled mode. The change request may be a change request for changing the operation mode of the external apparatus to the remote control enabled mode.

According to another embodiment of the disclosure, there is provided an information processing method including: receiving, from a controller, a control request for remotely controlling an external apparatus connected to a connection unit by network communication; and transmitting, to the external apparatus, a change request so that the external apparatus is able to be remotely controlled, when the control request is received in the receiving of the control request and the external apparatus is not able to be remotely controlled.

According to still another embodiment of the disclosure, there is provided a program causing a computer to function as: a control request receiving unit receiving, from a controller, a control request for remotely controlling an external apparatus connected to a connection unit by network communication; and a change request transmitting unit transmitting, to the external apparatus, a change request so that the external apparatus is able to be remotely controlled, when the control request receiving unit receives the control request and the external apparatus is not able to be remotely controlled.

According to further still another embodiment, there is provided an information processing system including a controller and an information processing apparatus. The controller includes a control request transmitting unit transmitting, to the information processing apparatus, a control request for remotely controlling an external apparatus connected to the information processing apparatus by network communication. The information processing apparatus includes a connection unit connecting the external apparatus to the information processing apparatus, a control request receiving unit receiving, from the controller, the control request for remotely controlling the external apparatus by the network communication, and a change request transmitting unit transmitting, to the external apparatus, a change request so that the external apparatus is able to be remotely controlled, when the control request receiving unit receives the control request and the external apparatus is not able to be remotely controlled.

As described above, according to the embodiments of the disclosure, the external device can remotely be controlled out of the predetermined range by the user.

### BRIEF DESCRIPTION OF THE DRAWINGS

FIG. 1 is a diagram illustrating a 3 BOX system according to an embodiment of the disclosure;

FIG. 2 is a diagram schematically illustrating the configuration of an information processing system according to the embodiment of the disclosure;

FIG. 3 is a block diagram illustrating the functional configuration of the information processing system in FIG. 2;

FIG. 4 is a diagram illustrating a sequence of an operation mode changing process (a remote control disabled mode by an external apparatus) executed in the information processing system in FIG. 2;

FIG. 5 is a diagram illustrating a sequence of an operation mode changing process (a remote control enabled mode by an external apparatus) executed in the information processing system in FIG. 2;

FIG. 6 is a diagram illustrating a sequence of a DB information acquiring process (a remote control disabled mode by an external apparatus) executed in the information processing system in FIG. 2;

FIG. 7 is a diagram illustrating a sequence of a DB information acquiring process (a remote control enabled mode by an external apparatus) executed in the information processing system in FIG. 2;

FIG. 8 is a diagram illustrating a sequence of an operation mode changing process (an operation of a key of d DMS by a user) executed in the information processing system in FIG. 2;

FIG. 9 is a diagram illustrating a sequence of an operation mode changing process (an operation of an IR remote controller by a user) executed in the information processing system in FIG. 2; and

FIG. 10 is a diagram illustrating a sequence of a DB information acquiring process (an operation of a DMC by a user) executed in the information processing system in FIG. 2.

### DETAILED DESCRIPTION OF EMBODIMENTS

A preferred embodiment of the disclosure will be described with reference to the accompanying drawings. The same reference numerals are given to constituent elements having substantially the same functions throughout the specification and the drawings and the description thereof will not be repeated.

The description will be made in the following order.

1. 3 BOX System

2. Information Processing System

3. Operation Mode Changing Process (Remote Control Disabled Mode of External Apparatus)

4. Operation Mode Changing Process (Remote Control Enabled Mode of External Apparatus)

5. DB Information Acquiring Process (Remote Control Disabled Mode of External Apparatus)

6. DB Information Acquiring Process (Remote Control Enabled Mode of External Apparatus)

7. Operation Mode Changing Process (Operation of Key of DMS by User)

8. Operation Mode Changing Process (Operation of IR Remote Controller by User)

9. DB Information Acquiring Process (Operation of DMC by User)

1. 3 BOX System

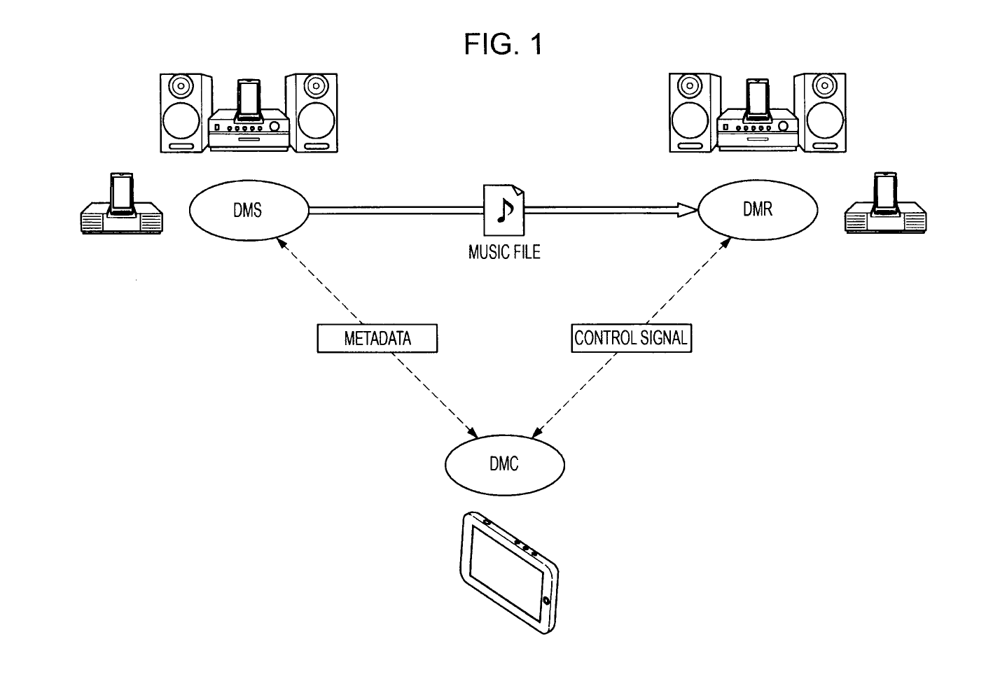

First, a 3 BOX system according to the embodiment of the disclosure will be described. FIG. 1 is a diagram illustrating the 3 BOX system according to the embodiment of the disclosure.

In FIG. 1, a DMS (Digital Media Server) stores content items such as music files and transmit a content item to a DMP (Digital Media Player) (not shown) or a DMR (Digital Media Renderer) connected to a network, so that the DMP or the DMR can reproduce the content item.

The DMP is configured to retrieve the content items stored in the DMS and reproduce the content item. The DMR is configured to render (display) the content item transmitted from the DMS.

A DMC (Digital Media Controller) acquires metadata of the content items from the DMS, retrieves the content items stored in the DMS, transmits the retrieved content items, transmits a control signal to the DMR, and allows (displays) to the DMR to render the content items.

In the 3 BOX system, all of the operations are performed by the DMC. For example, a user uses the DMC to acquire the metadata of the content items from the DMS, retrieve the content items from the DMS, transmit the retrieved content items to the DMR, transmit a control signal to the DMR, and allow the DMR to render (display) the content items.

2. Information Processing System

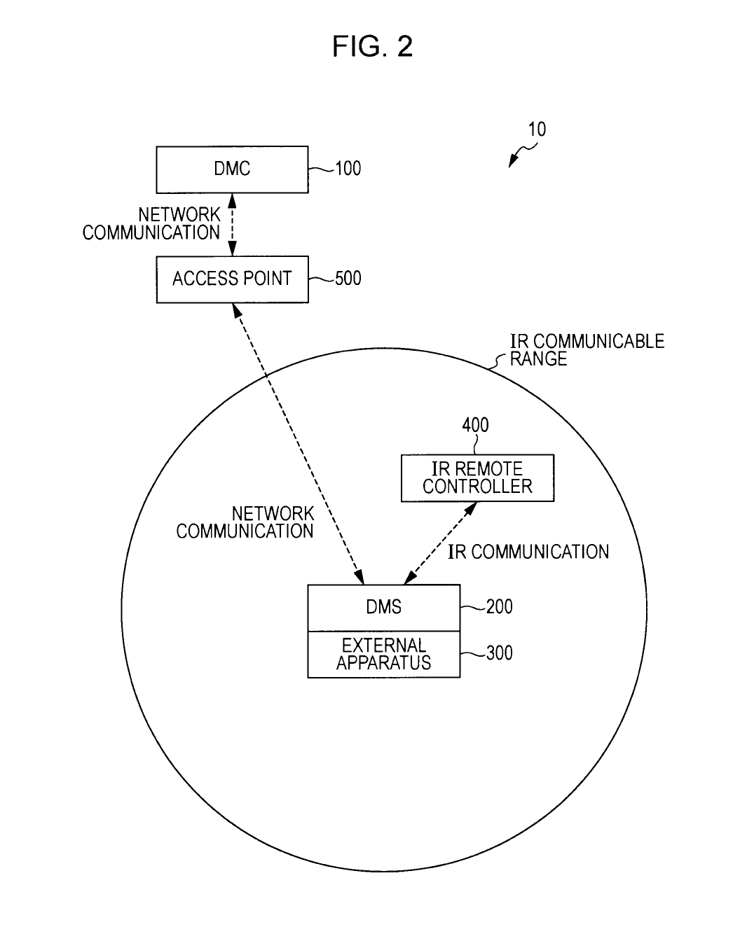

Next, an information processing system according to the embodiment of the disclosure will be described. FIG. 2 is a diagram schematically illustrating the configuration of the information processing system according to the embodiment of the disclosure.

Hereinafter, the description will be made, for example, by using a DLNA (Digital Living Network Alliance) as a network, using the DMC in the DLNA as a controller according to the embodiment of the disclosure, and using the DMS in the DLNA as the information processing apparatus according to the embodiment of the disclosure. However, the network, the controller, and the information processing apparatus according to this embodiment may not necessarily be the network and electronic apparatuses corresponding to the DLNA.

That is, the network according to this embodiment is not particularly limited. For example, IEEE 802.3 (Ethernet (registered trademark)), USB (Universal Serial Bus), HDMI (High-Definition Multimedia Interface), IEEE 1394, IEEE 802.11 (wireless LAN), Bluetooth (registered trademark), or the like may be used.

The controller and the information processing apparatus according to this embodiment includes all types of apparatuses such as a television, a recorder, an audio system, and a PC, as long as the apparatuses can be connected to any network exemplified above.

In FIG. 2, the information processing system 10 includes a DMC 100, a DMS 200, and an external apparatus 300. The external apparatus 300 is connected to the DMS 200. In the information processing system 10, the DMC 100 and the DMS 200 can perform bi-directional communication via an access point 500 by network communication.

When the user executes an operation to change an operation mode of the external apparatus 300, the DMC 100 transmits an operation mode changing request for changing the operation mode of the external apparatus 300 to the DMS 200 by the network communication. When the user executes a browse operation of the external apparatus 300, the DMC 100 transmits a browse request for the external apparatus 300 to the DMS 200 by the network communication. The operation mode changing request and the browse request are examples of a control request according to the embodiment of the disclosure.

The DMS 200 can connect the external apparatus 300. For example, when the DMS 200 receives the operation mode changing request from the DMC 100, the DMS 200 transmits, to the external apparatus 300, the operation mode changing request for changing the operation mode to the external apparatus 300 in accordance with the operation mode. The operation mode changing request is an example of a change request according to the embodiment of the disclosure.

For example, when the DMS 200 receives the browse request of the external apparatus 300 from the DMC 100, the DMS 200 transmits, to the external apparatus 300, the operation mode changing request for changing the operation mode to the external apparatus 300. In order to read information regarding a DB (database) of the external apparatus 300, the DMS 200 transmits a DB information request for acquiring the information regarding the DB of the external apparatus 300 to the external apparatus 300. When the DMS 200 receives the information regarding the DB from the external apparatus 300, the DMS 200 stores the received information regarding the DB and transmits the received information regarding the DB from the external apparatus 300 to the DMC 100 by the network communication. The DMS 200 may read content data from the DB of the external apparatus 300 or may read metadata of a content item. Further, the DMS 200 may transmit the content data of the DB of the external apparatus 300 or the metadata of the content item to the DMS 100 by the network communication, when the DMS 200 reads the content data from the DB of the external apparatus 300.

The external apparatus 300 is, for example, a portable content reproducing apparatus and can be connected to the DMS 200. The external apparatus 300 has operation modes such as a remote control disabled mode and a remote control enabled mode. The remote control disabled mode is a mode of not acquiring the information regarding the DB of the external apparatus 300 from the outside and is a mode of basically controlling the external apparatus 300 by, for example, a key operation of the external apparatus 300. The remote control enabled mode is a mode of acquiring the information regarding the DB of the external apparatus 300 from the outside and is a mode of remotely controlling the external apparatus 300.

When the external apparatus 300 receives the operation mode changing mode request from the DMS 200, the external apparatus 300 changes the operation mode. Further, when the external apparatus 300 receives the DB information request from the DMS 200, the external apparatus 300 transmits the information regarding the DB of the external apparatus 300 to the DMS 200.

In FIG. 2, when the user executes, for example, a key operation on the IR remote controller 400 to change the operation mode of the external apparatus 300 within an IR communicable range, the IR remote controller 400 transmits the operation mode changing request for changing the operation node of the external apparatus 300 to the DMS 200 by IR communication.

For example, when the DMS 200 receives the operation mode changing request from the IR remote controller 400 by the IR communication, the DMS 200 transmits the operation mode changing request for changing the operation mode to the external apparatus 300 in accordance with the operation mode of the external apparatus 300.

Further, when the user executes, for example, a key operation on a input unit 208 of the DMS 200 to execute an operation mode changing operation of changing the operation mode of the external apparatus 300 to the remote control enabled mode, the DMS 200 transmits the operation mode changing request for changing the operation mode to the external apparatus 300 in accordance with the operation mode of the external apparatus 300.

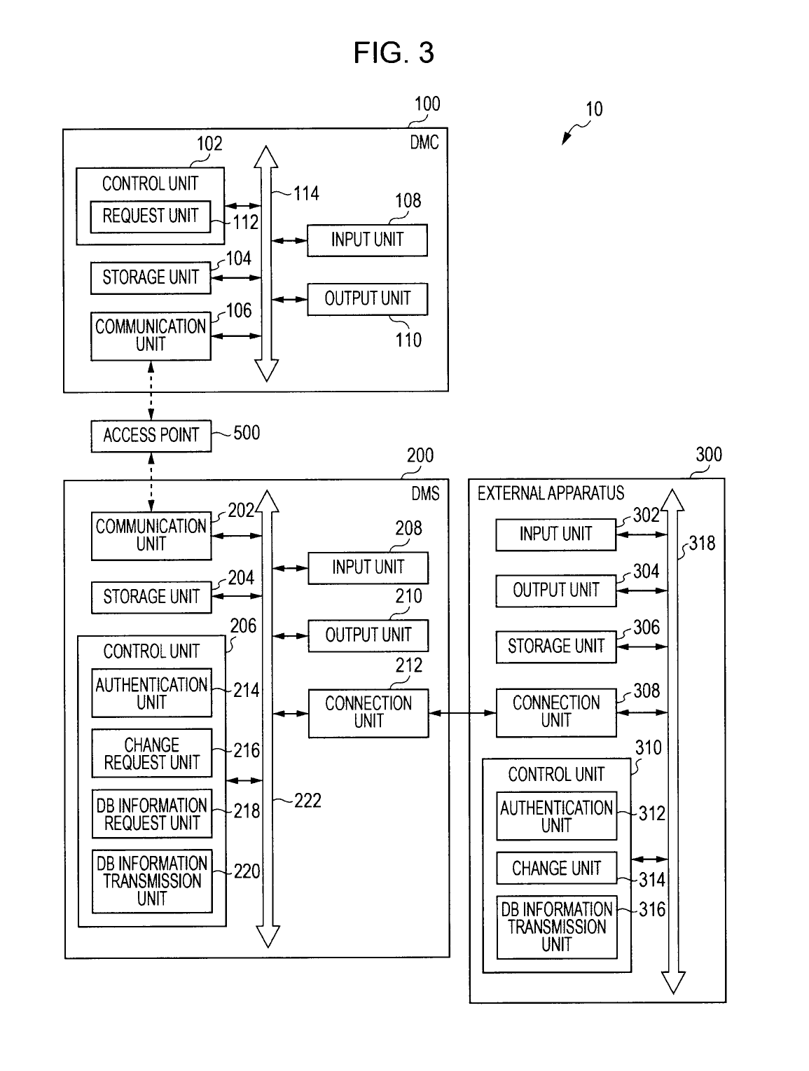

Next, the functional configuration of the information processing system 10 in FIG. 2 will be described. FIG. 3 is a block diagram illustrating the function configuration of the information processing system 10 in FIG. 2.

In FIG. 3, the DMC 100 includes a control unit 102, a storage unit 104, a communication unit 106, an input unit 108, an output unit 110, and a bus 114 communicating these units with each other.

The control unit 102 functions as an arithmetic processing unit and a control unit. For example, the control unit 102 controls all or some of the operations of the DMC 100 in accordance with various programs stored in the storage unit 104. The storage unit 104 is configured by a ROM, a RAM, or the like, stores the programs used by the control unit 102, arithmetic parameters, and the like, and temporarily stores a program being executed by the control unit 102, a parameter appropriately changed in the execution of the program, and the like.

The communication unit 106 is a communication interface configured by a communication device or the like for network communication. For example, the communication unit 106 is a wired or wireless LAN (Local Area Network), a communication card for Bluetooth or WUSB (Wireless USB), a router for optical communication, a router for ADSL (Asymmetric Digital Subscriber Line), or a modem for various kinds of communications. The communication unit 106 can transmit and receive data to and from, for example, the Internet or another communication apparatus. A communication network connected to the communication unit 106 is configured as a network connected in a wired or wireless way and may be, for example, the Internet, a house LAN, infrared communication, satellite communication, or the like.

The input unit 108 is an operation unit such as a touch panel, a button, or a switch which is operated by the user. Further, the input unit 108 is configured by an input control circuit or the like that generates an input signal based on information input by the user by using, for example, the above operation unit and outputs the generated input signal to the control unit 102. The user of the DMC 100 operates the input unit 108 to input various kinds of data to the DMC 100 or give an instruction for a process.

The output unit 110 is configured by a device that can visually or audibly provide a user with acquired information, for example, a display device such as a CRT display device, a liquid crystal display device, a plasma display device, an EL display device, or a lamp or an audio output device such as a speaker or a headphone. The output unit 110 of the DMC 100 outputs a list of servers such as the DMS 200 which can be controlled by the DMC 100 or an image signal associated with a list of content items stored in the DMS 200. Specifically, the display device displays various kinds of information such as image data in the form of a text or an image. On the other hand, the audio output device converts audio data into a voice and outputs the voice.

The control unit 102 includes a request unit 112. The request unit 112 is an example of a control request transmitting unit according to the embodiment of the disclosure. When the user executes an operation of changing the operation mode of the external apparatus 300 to the remote control enabled mode, the request unit 112 transmits the operation mode changing request for changing the operation mode of the external apparatus 300 to the remote control enabled mode to the DMS 200 by network communication. Further, when the user executes the browse operation of the external apparatus 300, the request unit 112 transmits the browse request of the external apparatus 300 to the DMS 200 by the network communication.

For example, the storage unit 104 stores the information regarding the DB of the external apparatus 300 transmitted from the DMS 200 by the network communication.

The communication unit 106 transmits the operation mode changing request for changing the operation mode of the external apparatus 300 to the remote control enabled mode to the DMS 200 by the network communication executed via the access point 500. The communication unit 106 transmits the browse request of the external apparatus 300 to the DMS 200 by the network communication executed via the access point 500.

The DMS 200 includes a communication unit 202, a storage unit 204, a control unit 206, the input unit 208, an output unit 210, a connection unit 212, and a bus 222 communicating these units with each other.

The communication unit 202 is, for example, a communication interface configured by a communication device for network communication. For example, the communication unit 202 is a wired or wireless LAN, a communication card for Bluetooth or WUSB, a router for optical communication, a router for ADSL, or a modem for various kinds of communications. The communication unit 202 can transmit and receive data to and from, for example, the Internet or another communication apparatus. A communication network connected to the communication unit 202 is configured as a network connected in a wired or wireless way and may be, for example, the Internet, a house LAN, infrared communication, satellite communication, or the like.

The storage unit 204 is configured by a ROM, a RAM, or the like, stores the programs used by the control unit 206, arithmetic parameters, and the like, and temporarily stores a program being executed by the control unit 206, a parameter appropriately changed in the execution of the program, and the like. The control unit 206 functions as an arithmetic processing unit and a control unit. For example, the control unit 206 controls all or some of the operations of the DMS 200 in accordance with various programs stored in the storage unit 204.

The input unit 208 is an operation unit such as a mouse, a keyboard, a touch panel, a button, a switch, or a lever operated by the user. For example, the input unit 208 may be a remote control unit (so-called remote controller) using infrared rays or other radio waves or may be an external connection apparatus such as a cellular phone or a PDA corresponding to an operation of the DMS 200. Further, the input unit 208 is configured by an input control circuit or the like that generates an input signal based on information input by the user by the use of, for example, the operation unit and output the input signal to the control unit 206. The user of the DMS 200 can operate the input unit 208 to input various kinds of data to the DMS 200 or give an instruction of a process.

The output unit 210 is configured by a device that can visually or audibly provide a user with acquired information, for example, a display device such as a CRT display device, a liquid crystal display device, a plasma display device, an EL display device, or a lamp or an audio output device such as a speaker or a headphone. The output unit 210 of the DMS 200 outputs an image signal associated with the content items stored in the storage unit 204. Specifically, the display device displays various kinds of information such as image data in the form of a text or an image. On the other hand, the audio output device converts audio data into a voice and outputs the voice. The connection unit 212 is an example of a DB information receiving unit according to the embodiment of the disclosure and is a port to which the external apparatus 300 is directly connected.

The control unit 206 includes an authentication unit 214, a change request unit 216, a DB information request unit 218, and a DB information transmission unit 220.

The authentication unit 214 authenticates the external apparatus 300 connected to the connection unit 212 and transmits authentication information to authenticate the DMS 200 to the external apparatus 300. The change request unit 216 is an example of a change request transmitting unit according to the embodiment of the disclosure. When the change request unit 216 receives an operation mode changing request from the DMC 100 and the operation mode of the external apparatus 300 is the remote control disabled mode, the change request unit 216 transmits the operation mode changing request for changing the operation mode to the remote control enable mode to the external apparatus 300. Further, when the change request unit 216 receives the browse request of the external apparatus 300 from the DMC 100 and the operation mode of the external apparatus 300 is the remote control disabled mode, the change request unit 216 transmits the operation mode changing request for changing the operation mode to the remote control enabled mode to the external apparatus 300.

The DB information request unit 218 is an example of a DB information request transmitting unit according to the embodiment of the disclosure. When the DB information request unit 218 receives the browse request of the external apparatus 300 from the DMC 100 or the operation mode of the external apparatus 300 is changed to the remote control enabled mode as the result obtained when the change request unit 216 transmits, to the external apparatus 300, the operation mode changing request for changing the operation mode to the remote control enabled mode to the external apparatus 300, the DB information request unit 218 transmits the DB information request to acquire the DB information of the storage unit 306 of the external apparatus 300 to the external apparatus 300.

When the DB information transmission unit 220 receives the DB information from the external apparatus 300, the DB information transmission unit 220 transmits the DB information received from the external apparatus 300 to the DMC 100 by the network communication.

The communication unit 202 is an example of a control request receiving unit according to the embodiment of the disclosure. The communication unit 202 receives the operation mode changing request transmitted from the DMC 100 by the network communication. Further, the communication unit 202 receives the browse request of the external apparatus 300 transmitted from the DMC 100 by the network communication. Furthermore, the communication unit 202 transmits the DB information received from the external apparatus 300 to the DMC 100 by the network communication. The storage unit 204 is an example of the DB information storage unit according to the embodiment of the disclosure. The storage unit 204 stores the DB information transmitted from the external apparatus 300.

The external apparatus 300 includes an input unit 302, an output unit 304, a storage unit 306, a connection unit 308, a control unit 310, and a bus 318 communicating these units with each other.

The input unit 302 is an operation unit such as a touch panel, a button, or a switch which is operated by the user. Further, the input unit 302 is configured by an input control circuit or the like that generates an input signal based on information input by the user by using, for example, the above operation unit and outputs the generated input signal to the control unit 310. The user of the external apparatus 300 operates the input unit 302 to input various kinds of data to the external apparatus 300 or give an instruction for a process.

The output unit 304 is configured by a device that can visually or audibly provide the user with acquired information, for example, a display device such as a CRT display device, a liquid crystal display device, a plasma display device, an EL display device, or a lamp or an audio output device such as a speaker or a headphone. For example, the output unit 304 of the external apparatus 300 outputs an image signal associated with the list of the content items stored in the storage unit 306. Specifically, the display device displays various kinds of information such as image data in the form of a text or an image. On the other hand, the audio output device converts audio data into a voice and outputs the voice.

The storage unit 306 is configured by a ROM, a RAM, or the like, stores the programs used by the control unit 310, arithmetic parameters, and the like, and temporarily stores a program being executed by the control unit 310, a parameter appropriately changed in the execution of the program, and the like. The connection unit 308 is a port to which the DMS 200 is directly connected. The control unit 310 functions as an arithmetic processing unit and a control unit. For example, the control unit 310 controls all or some of the operations of the external apparatus 300 in accordance with various programs stored in the storage unit 306.

The control unit 310 includes an authentication unit 312, a change unit 314, and a DB information transmission unit 316.

The authentication unit 312 authenticates the DMS 200 connected to the connection unit 308 and transmits authentication information to authenticate the external apparatus 300 to the DMS 200. When the change unit 314 receives the operation mode changing request for changing the operation mode to the remote control enabled mode from the DMS 200, the change unit 314 changes the operation mode of the external apparatus 300 so that the operation mode is changed to the remote control enabled mode. Further, when the change unit 314 receives the operation mode changing request for changing the operation mode to the remote control disabled mode from the DMS 200, the change unit 314 changes the operation mode of the external apparatus 300 so that the operation mode is changed to the remote control disabled mode. When the DB information transmission unit 316 receives the DB information request from the DMS 200, the DB information transmission unit 316 transmits the DB information of the storage unit 306 to the DMS 200.

3. Operation Mode Changing Process (Remote Control Disabled Mode of External Apparatus)

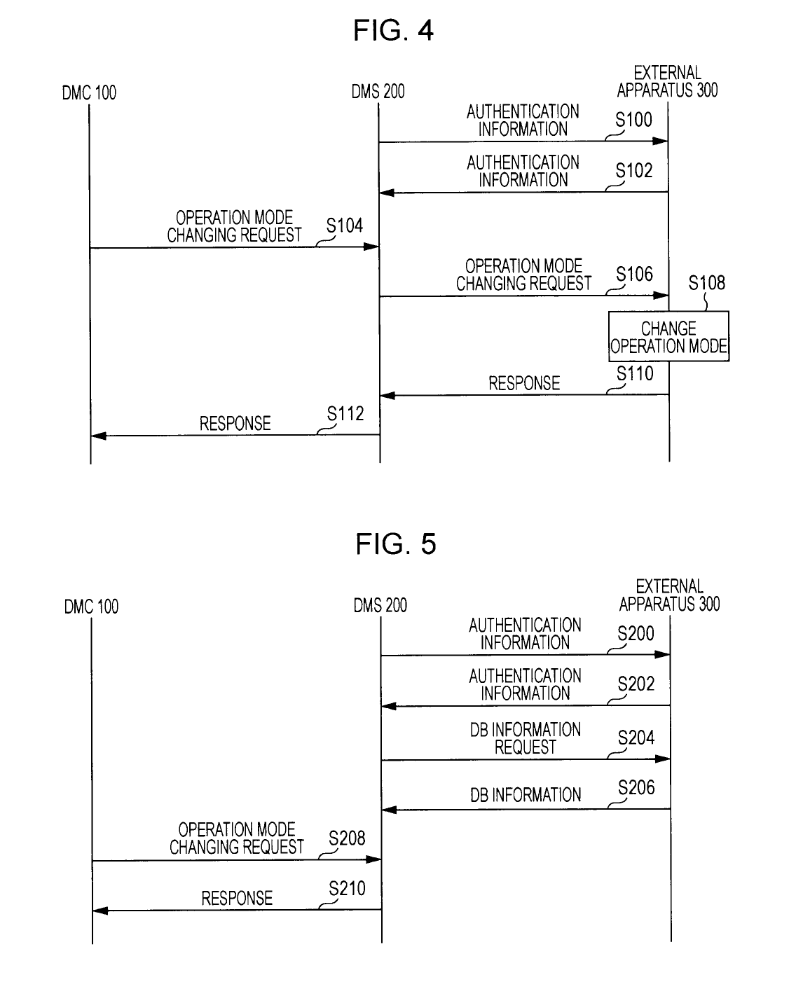

Next, an operation mode changing process (remote control disabled mode of an external apparatus) performed by the information processing system 10 in FIG. 2 will be described. FIG. 4 is a diagram illustrating a sequence of the operation mode changing process (remote control disabled mode of an external apparatus) performed by the information processing system 10 in FIG. 2. The operation mode changing process is a process that is performed when the external apparatus connected to the DMS 200 is operated in the remote control disabled mode in the previous process.

In FIG. 4, when the external apparatus 300 is connected to the DMS 200, the DMS 200 first transmits authentication information to the external apparatus 300 to authenticate the DMS 200 to the external apparatus 300 (step S100). Moreover, the external apparatus 300 transmits the authentication information to the DMS 200 to authenticate the external apparatus 300 to the DMS 200 (step S102). In this way, the DMS 200 and the external apparatus 300 mutually perform the authentication.

Subsequently, the DMS 200 reads information, which is stored in the storage unit 204, regarding the operation mode of the external apparatus connected to the DMS 200 in the previous process and transmits the operation mode changing request to the external apparatus 300 so that the operation mode of the external apparatus 300 connected in the current process is changed to the same mode as the operation mode of the external apparatus in the previous process, that is, is changed to the remote control disabled mode. Then, the external apparatus 300 receiving the operation mode changing request performs the operation mode changing process to change the operation mode to the remote control disabled mode.

Subsequently, when the user executes an operation to change the operation mode of the external apparatus 300 to the remote control enabled mode, the DMC 100 transmits the operation mode changing request for changing the operation mode of the external apparatus 300 to the remote control enabled mode to the DMS 200 by the network communication (step S104).

Subsequently, when the DMS 200 receives the operation mode changing request from the DMC 100 by the network communication, the DMS 200 transmits the operation mode changing request for changing the operation mode of the external apparatus 300 to the remote control enabled mode to the external 300 since the operation mode of the external apparatus 300 is the remote control disabled mode (step S106).

Subsequently, when the external apparatus 300 receives the operation mode changing request from the DMS 200, the external apparatus 300 performs the operation mode changing process to change the operation mode to the remote control enabled mode (step S108).

Subsequently, the external apparatus 300 transmits, to the DMS 200, a response to the operation mode changing request received from the DMS 200 to indicate that the operation mode is changed to the remote control enabled mode (step S110).

Subsequently, when the DMS 200 receives the response indicating the operation mode is changed to the remote control enabled mode from the external apparatus 300, the DMS 200 transmits, to the DMC 100, a response to the operation mode changing request received from the DMC 100 by the network communication to indicate the operation mode is changed to the remote control enabled mode (step S112) and ends this operation mode changing process.

According to the operation mode changing process (the remote control disabled mode) in FIG. 4, the DMS 200 receives the operation mode changing request from the DMC 100 by the network communication and transmits the operation mode changing request for changing the operation mode to the remote control enabled mode to the external apparatus 300. Since there is no restriction on the communicable range in the network communication, the user of the DMC 100 can remotely control the external apparatus 300 connected to the DMS 200 out of a predetermined IR communicable range. For example, by the network communication using the DLNA, the user located in another room can remotely control the external apparatus 300 connected to the DMS 200 installed in a room using the DMC 100.

4. Operation Mode Changing Process (Remote Control Enabled Mode of External Apparatus)

Next, the operation mode changing process (the remote control enabled mode) performed by the information processing system 10 in FIG. 2 will be described. FIG. 5 is a diagram illustrating a sequence of the operation mode changing process (the remote control enabled mode of the external apparatus) performed by the information processing system 10 in FIG. 2. The operation mode changing process is a process that is performed when the external apparatus connected to the DMS 200 is operated in the remote control enabled mode in the previous process.

In FIG. 5, when the external apparatus 300 is connected to the DMS 200, the DMS 200 first transmits authentication information to the external apparatus 300 to authenticate the DMS 200 to the external apparatus 300 (step S200). Moreover, the external apparatus 300 transmits the authentication information to the DMS 200 to authenticate the external apparatus 300 to the DMS 200 (step S202). In this way, the DMS 200 and the external apparatus 300 mutually perform the authentication.

Subsequently, the DMS 200 reads information, which is stored in the storage unit 204, regarding the operation mode of the external apparatus connected to the DMS 200 in the previous process and transmits the operation mode changing request to the external apparatus 300 so that the operation mode of the external apparatus 300 connected in the current process is changed to the same mode as the operation mode of the external apparatus in the previous process, that is, is changed to the remote control enable mode. Then, the external apparatus 300 receiving the operation mode changing request performs the operation mode changing process to change the operation mode to the remote control enabled mode.

Subsequently, since the operation mode of the external apparatus 300 is the remote control enable mode, the DMS 200 transmits the DB information request for acquiring the DB information of the storage unit 306 of the external apparatus 300 to the external apparatus 300 in order to predict the DB information of the storage unit 306 of the external apparatus 300 (step S204).

Subsequently, when the external apparatus 300 receives the DB information request from the DMS 200, the external apparatus 300 transmits the DB information of the storage unit 306 to the DMS 200 (step S206).

Subsequently, when the DMS 200 receives the DB information from the external apparatus 300, the DMS 200 stores the received DB information in the storage unit 204.

Subsequently, when the user executes an operation to change the operation mode of the external apparatus 300 to the remote control enabled mode, the DMC 100 transmits the operation mode changing request for changing the operation mode of the external apparatus 300 to the remote control enabled mode to the DMS 200 by the network communication (step S208).

Subsequently, when the DMS 200 receives the operation mode changing request from the DMC 100 by the network communication, the DMS 200 transmits, to the DMC 100, a response to the operation mode changing request received from the DMC 100 to indicate that the operation mode of the external apparatus 300 is already changed to the remote control enabled mode since the operation mode of the external apparatus 300 is already the remote control enabled mode (step S210) and ends this operation mode changing process.

According to the operation mode changing process (the remote control enabled mode of the external apparatus) in FIG. 5, as described above, the user of the DMC 100 can remotely control the external apparatus 300 out of the predetermined IR communicable range.

5. DB Information Acquiring Process (Remote Control Disabled Mode of External Apparatus)

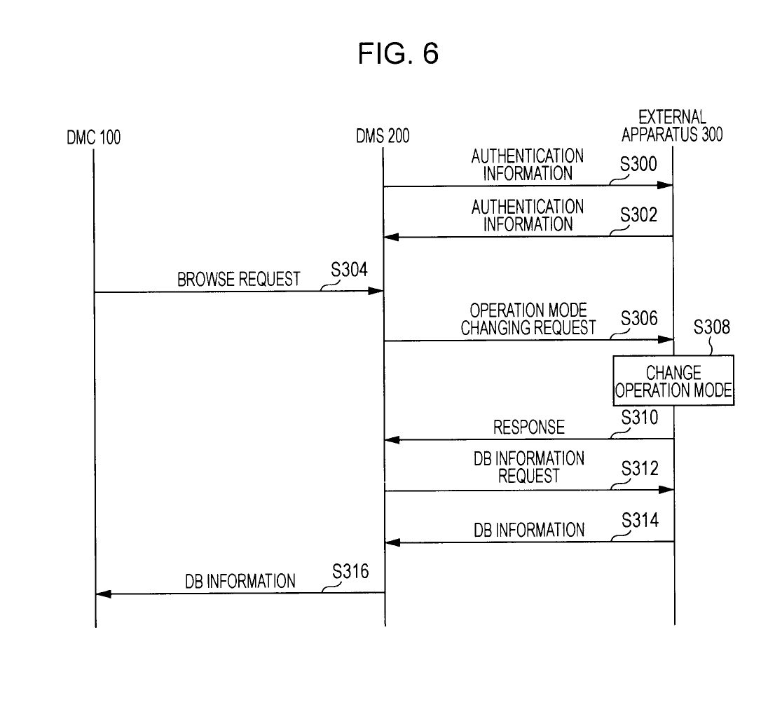

Next, a DB information acquiring process (the remote control disabled mode) performed by the information processing system 10 in FIG. 2 will be described. FIG. 6 is a diagram illustrating a sequence of the DB information acquiring process (the remote control disabled mode of the external apparatus) performed by the information processing system 10 in FIG. 2. This DB information acquiring process is a process that is performed when the external apparatus connected to the DMS 200 is operated in the remote control disabled mode in the previous process.

In FIG. 6, when the external apparatus 300 is connected to the DMS 200, the DMS 200 first transmits authentication information to the external apparatus 300 to authenticate the DMS 200 to the external apparatus 300 (step S300). Moreover, the external apparatus 300 transmits the authentication information to the DMS 200 to authenticate the external apparatus 300 to the DMS 200 (step S302). In this way, the DMS 200 and the external apparatus 300 mutually perform the authentication.

Subsequently, the DMS 200 reads information, which is stored in the storage unit 204, regarding the operation mode of the external apparatus connected to the DMS 200 in the previous process and transmits the operation mode changing request to the external apparatus 300 so that the operation mode of the external apparatus 300 connected in the current process is changed to the same mode as the operation mode of the external apparatus in the previous process, that is, is changed to the remote control disabled mode. Then, the external apparatus 300 receiving the operation mode changing request performs the operation mode changing process to change the operation mode to the remote control disabled mode.

Subsequently, when the user executes the browse operation of the external apparatus 300, the DMC 100 transmits the browse request of the external apparatus 300 to the DMS 200 by the network communication (step S304).

Subsequently, when the DMS 200 receives the browse request of the external apparatus 300 from the DMC 100 by the network communication, the DMS 200 transmits the operation mode changing request for changing the operation mode of the external apparatus 300 to the remote control enabled mode to the external 300 since the operation mode of the external apparatus 300 is the remote control disabled mode (step S306).

Subsequently, when the external apparatus 300 receives the operation mode changing request from the DMS 200, the external apparatus 300 performs the operation mode changing process to change the operation mode to the remote control enabled mode (step S308).

Subsequently, the external apparatus 300 transmits, to the DMS 200, a response to the operation mode changing request received from the DMS 200 to indicate that the operation mode is changed to the remote control enabled mode (step S310).

Subsequently, when the DMS 200 receives the response indicating the operation mode is changed to the remote control enabled mode from the external apparatus 300, the DMS transmits, to the external apparatus 300, the DB information request for acquiring the DB information of the storage unit 306 of the external apparatus 300 in order to read the DB information of the storage unit 306 of the external apparatus 300, since the operation mode of the external apparatus 300 is the remote control enabled mode (step S312).

Subsequently, when the external apparatus 300 receives the DB information request from the DMS 200, the external apparatus 300 transmits the DB information of the storage unit 306 to the DMS 200 (step S314).

Subsequently, when the DMS 200 receives the DB information from the external apparatus 300, the DMS 200 stores the received DB information in the storage unit 204.

Subsequently, the DMS 200 transmits the DB information received from the external apparatus 300 to the DMC 100 by the network communication (step S316) and ends this DB information acquiring process.

According to the DB information acquiring process (the remote control disabled mode) in FIG. 6, as described above, the user of the DMC 100 can remotely control the external apparatus 300 out of the predetermined IR communicable range. The DMC 100 receives the DB information of the external apparatus 300 from the DMS 200 by the network communication. The DMC 100 can improve convenience for the remote control of the external apparatus 300 by the user of the DMC 100 by displaying the DB information (meta information) received through the output unit 110 in the form of a text or an image. For example, when the user of the DMC 100 remotely controls the external apparatus 300 to perform reproduction, the user can designate a content item from the text or the image displayed on the output unit 110 of the DMC 100, and thus can reproduce the desired content item.

6. DB Information Acquiring Process (Remote Control Enabled Mode of External Apparatus)

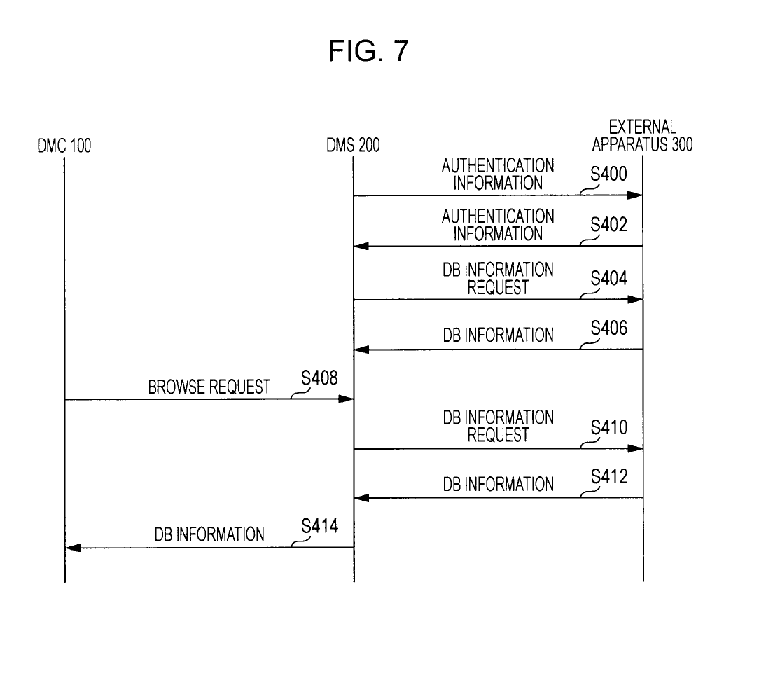

Next, a DB information acquiring process (the remote control enabled mode of the external apparatus) performed by the information processing system 10 in FIG. 2 will be described. FIG. 7 is a diagram illustrating a sequence of the DB information acquiring process (the remote control enabled mode of the external apparatus) performed by the information processing system 10 in FIG. 2. This DB information acquiring process is a process that is performed when the external apparatus connected to the DMS 200 is operated in the remote control enabled mode in the previous process.

In FIG. 7, when the external apparatus 300 is connected to the DMS 200, the DMS 200 first transmits authentication information to the external apparatus 300 to authenticate the DMS 200 to the external apparatus 300 (step S400). Moreover, the external apparatus 300 transmits the authentication information to the DMS 200 to authenticate the external apparatus 300 to the DMS 200 (step S402). In this way, the DMS 200 and the external apparatus 300 mutually perform the authentication.

Subsequently, the DMS 200 reads information, which is stored in the storage unit 204, regarding the operation mode of the external apparatus connected to the DMS 200 in the previous process and transmits the operation mode changing request to the external apparatus 300 so that the operation mode of the external apparatus 300 connected in the current process is changed to the same mode as the operation mode of the external apparatus in the previous process, that is, is changed to the remote control enabled mode. Then, the external apparatus 300 receiving the operation mode changing request performs the operation mode changing process to change the operation mode to the remote control enabled mode.

Subsequently, since the operation of mode of the external apparatus 300 is the remote control enabled mode, the DMS 200 transmits, to the external apparatus 300, the DB information request for acquiring the DB information of the storage unit 306 of the external apparatus 300 in order to predict the DB information of the storage unit 306 of the external apparatus 300 (step S404).

Subsequently, when the external apparatus 300 receives the DB information request from the DMS 200, the external apparatus 300 transmits the DB information of the storage unit 306 to the DMS 200 (step S406).

Subsequently, when the DMS 200 receives the DB information from the external apparatus 300, the DMS 200 stores the received DB information in the storage unit 204.

Subsequently, when the user executes the browse operation of the external apparatus 300, the DMC 100 transmits the browse request of the external apparatus 300 to the DMS 200 by the network communication (step S408).

Subsequently, when the DMS 200 receives the browse request of the external apparatus 300 from the DMC 100 by the network communication, the DMS 200 transmits, to the external apparatus 300, the DB information request for acquiring the DB information of the storage unit 306 of the external apparatus 300 in order to read the DB information of the storage unit 306 of the external apparatus 300 since the operation mode of the external apparatus 300 is the remote control enabled mode (step S410).

Subsequently, when the external apparatus 300 receives the DB information request from the DMS 200, the external apparatus 300 transmits the DB information of the storage unit 306 to the DMS 200 (step S412).

Subsequently, when the DMS 200 receives the DB information from the external apparatus 300, the DMS 200 stores the received DB information in the storage unit 204.

Subsequently, the DMS 200 transmits the DB information received from the external apparatus 300 to the DMC 100 by the network communication (step 5414) and ends this DB information acquiring process.

According to the DB information acquiring process (the remote control disabled mode) in FIG. 7, as described above, the user of the DMC 100 can remotely control the external apparatus 300 out of the predetermined IR communicable range. As described above, the DMC 100 can improve convenience for the remote control of the external apparatus 300 by the user of the DMC 100 by displaying the DB information (meta information) received through the output unit 110 in the form of a text or an image.

7. Operation Mode Changing Process (Operation of Key of DMS by User)

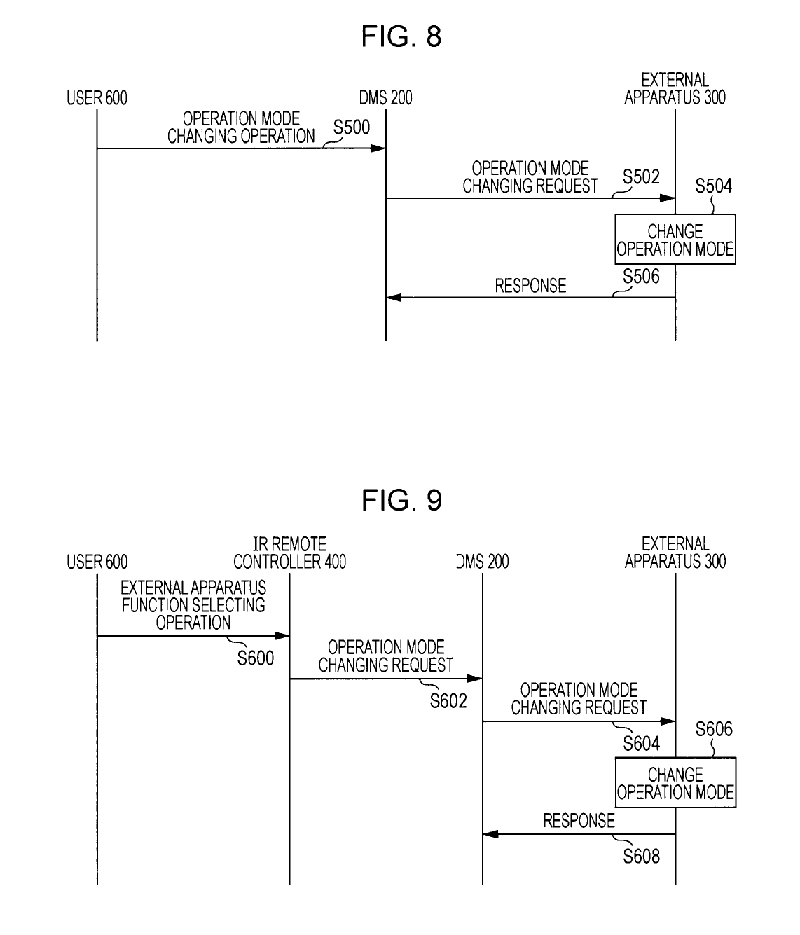

Next, an operation mode changing process (a key operation of the DMS by the user) performed in the information processing system 10 in FIG. 2 will be described. FIG. 8 is a diagram illustrating a sequence of the operation mode changing process (the key operation of the DMS by the user) performed in the information processing system 10 in FIG. 2. This operation mode changing process is a process that is performed when the external apparatus connected to the DMS 200 is operated in the remote control disabled mode. A process performed when the external apparatus connected to the DMS 200 is operated in the remote control enabled mode in the previous process will not be described.

In FIG. 8, when the user first operates, for example, a key of the input unit 208 of the DMS 200 to execute the operation mode changing operation of changing the operation mode of the external apparatus 300 to the remote control enabled mode (step S500), the DMS 200 transmits the operation mode changing request for changing the operation mode to the remote control enabled mode to the external apparatus 300 since the operation mode of the external apparatus 300 is the remote control disabled mode (step S502).

Subsequently, when the external apparatus 300 receives the operation mode changing request from the DMS 200, the external apparatus 300 performs the operation mode changing process to change the operation mode to the remote control enabled mode (step S504).

Subsequently, the external apparatus 300 transmits, to the DMS 200, a response to the operation mode changing request received from the DMS 200 to indicate that the operation mode is changed to the remote control enabled mode (step S506) and ends this operation mode changing process.

According to the operation mode changing process (the key of the DMS by the user) in FIG. 8, the operation mode of the external apparatus 300 can be changed by, for example, the key operation on the input unit 208 of the DMS 200.

8. Operation Mode Changing Process (Operation of IR Remote Controller by User)

Next, an operation mode changing process (operation of the IR remote controller by the user) performed by the information processing system 10 in FIG. 2 will be described. FIG. 9 is a diagram illustrating a sequence of the operation mode changing process (the operation of the IR remote controller by the user) performed by the information processing system 10 in FIG. 2. This operation mode changing process is a process that is performed when the external apparatus connected to the DMS 200 is operated in the remote control disabled mode. A process performed when the external apparatus connected to the DMS 200 is operated in the remote control enabled mode in the previous process will not be described.

In FIG. 9, when the user operates, for example, a key of an input unit (not shown) of the IR remote controller 400 to select a function of the external apparatus (step S600), the IR remote controller 400 first transmits, to the DMS 200, the operation mode changing request for changing the operation mode of the external apparatus 300 to the remote control enabled mode by IR communication (step S602).

Subsequently, when the DMS 200 receives the operation mode changing request from the IR remote controller 400 by the IR communication, the DMS 200 transmits, to the external apparatus 300, the operation mode changing request for changing the operation mode to the remote control enabled mode since the operation mode of the external apparatus 300 is the remote control disabled mode (step S604).

Subsequently, when the external apparatus 300 receives the operation mode changing request from the DMS 200, the external apparatus 300 performs the operation mode changing process to change the operation mode to the remote control enabled mode (step S606).

Subsequently, the external apparatus 300 transmits, to the DMS 200, a response to the operation mode changing request received from the DMS 200 to indicate that the operation mode is changed to the remote control enabled mode (step 5608) and ends this operation mode changing process.

According to the operation mode changing process (the operation of the IR remote controller by the user) in FIG. 9, the operation mode of the external apparatus 300 can be changed by the operation mode changing request from the IR remote controller 400 by the IR communication.

9. DB Information Acquiring Process (Operation of DMC by User)

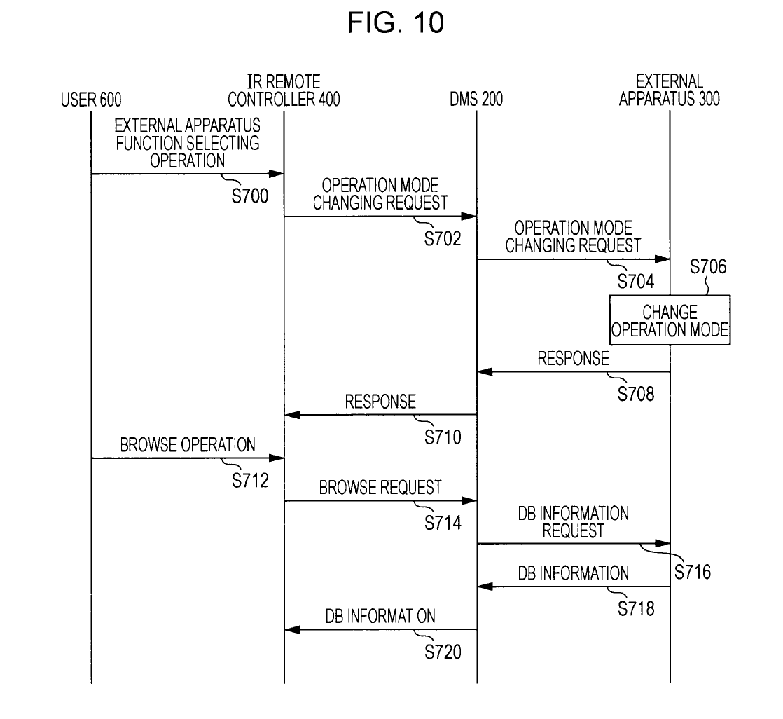

Next, a DB information acquiring process (operation of the DMC by the user) performed by the information processing system 10 in FIG. 2 will be described. FIG. 10 is a diagram illustrating a sequence of the DB information acquiring process (the operation of the DMC by the user) performed by the information processing system 10 in FIG. 2. This DB information acquiring process is a process that is performed when the external apparatus connected to the DMS 200 is operated in the remote control disabled mode. A process performed when the external apparatus connected to the DMS 200 is operated in the remote control enabled mode in the previous process will not be described.

In FIG. 10, when the user selects a function of the external apparatus through the DMC 100 (step S700), the operation mode changing request for changing the operation mode of the external apparatus 300 to the remote control enabled mode is transmitted to the DMS 200 by the network communication (step S702).

Subsequently, when the DMS 200 receives the operation mode changing request from the DMC 100 by the network communication, the DMS 200 transmits, to the external apparatus 300, the operation mode changing request for changing the operation mode to the remote control enabled mode since the operation mode of the external apparatus 300 is the remote control disabled mode (step S704).

Subsequently, when the external apparatus 300 receives the operation mode changing request from the DMS 200, the external apparatus 300 performs the operation mode changing process to change the operation mode to the remote control enabled mode (step S706).

Subsequently, the external apparatus 300 transmits, to the DMS 200, a response to the operation mode changing request received from the DMS 200 to indicate that the operation mode is changed to the remote control enabled mode (step S708).

Subsequently, when the DMS 200 receives the response indicating the operation mode is changed to the remote control enabled mode from the external apparatus 300, the DMS 200 transmits, to the DMC 100, a response to the operation mode changing request received from the DMC 100 to indicate that the operation mode is changed to the remote control enabled mode (step S710).

Subsequently, when the user executes the browse operation of the external apparatus 300 through the DMC 100 (step S712), the DMC 100 transmits the browse request of the external apparatus 300 to the DMS 200 by the network communication (step S714).

Subsequently, when the DMS 200 receives the browse request of the external apparatus 300 from the DMC 100 by the network communication, the DMS 200 transmits, to the external apparatus 300, the DB information request for acquiring the DB information of the storage unit 306 of the external apparatus 300 in order to read the DB information of the storage unit 306 of the external apparatus 300 since the operation mode of the external apparatus 300 is the remote control enabled mode (step S716).

Subsequently, when the external apparatus 300 receives the DB information request from the DMS 200, the external apparatus 300 transmits the DB information of the storage unit 306 to the DMS 200 (step S718).

Subsequently, when the DMS 200 receives the DB information from the external apparatus 300, the DMS 200 stores the received DB information in the storage unit 204.

Subsequently, the DMS 200 transmits the DB information received from the external apparatus 300 to the DMC 100 by the network communication (step 5720) and ends this DB information acquiring process.

According to the DB information acquiring process (the operation of the DMC by the user) in FIG. 10, as described above, the user of the DMC 100 can remotely control the external apparatus 300 out of the predetermined IR communicable range. As described above, the DMC 100 can improve convenience for the remote control of the external apparatus 300 by the user of the DMC 100 by displaying the DB information (meta information) received through the output unit 110 in the form of a text or an image.

The embodiment of the disclosure is also realized by supplying a storage medium, which stores a program code of software realizing the functions of the above-described embodiment, to the system or the apparatus, causing a computer (or a CPU, MPU, or the like) of the system or the apparatus to read the program code stored in the storage medium, and executing the program code.

In this case, the program code itself read from the storage medium realizes the functions of the above-described embodiment, and thus the program code and the storage medium storing the program code constitute the embodiment of the disclosure.

Examples of the storage medium supplying the program code include a floppy (registered trademark), a hard disk, a magnetic optical disc, optical discs such as a CD-ROM, a CD-R, CD-RW, a DVD-ROM, a DVD-RAM, a DVD-RW, and a DVD+RW, a magnetic tape, a non-volatile memory card, and a ROM. The program code may be downloaded via a network.

Not only the functions of the above-described embodiment may be realized by executing the program code read by a computer, but also the functions of the above-described embodiment may be realized by all or some of the actual processes executed by an OS (Operating System) operated on a computer on the basis of an instruction of the program code.

Further, the functions of the above-described embodiment may be realized by all or some of the actual processes executed by a CPU or the like installed in a function expanding board inserted into a computer or a function expanding unit inserted into a computer based on an instruction of the program code, after the program code read by the storage medium is written on a memory included in the function expanding board or the function expanding unit.

The preferred embodiment of the disclosure has hitherto been described with reference to the accompanying drawings, but the disclosure is not limited to the embodiment of the disclosure. It is apparent to those skilled in the art that the embodiment may be modified or altered in various forms within the scope of the technical spirit described in the claims and, of course, the modifications and the alterations pertain to the technical scope of the disclosure.

For example, in the above-described embodiment, the DMC 100 transmits the request for changing the operation of the external apparatus 300 to the DMS 200. However, a request or the like for changing a reproduction mode of the external apparatus 300 may be likewise transmitted to the DMS 200 to change the reproduction mode or the like of the external apparatus 300.

The present disclosure contains subject matter related to that disclosed in Japanese Priority Patent Application JP 2010-204701 filed in the Japan Patent Office on Sep. 13, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a connection unit connecting an external apparatus to the information processing apparatus;
a control request receiving unit receiving, from a controller, a control request for remotely controlling the external apparatus by network communication; and
a change request transmitting unit transmitting, to the external apparatus, a change request so that the external apparatus is able to be remotely controlled, when the control request receiving unit receives the control request and the external apparatus is not able to be remotely controlled.

2. The information processing apparatus according to claim 1, further comprising:
a DB information request transmitting unit transmitting, to the external apparatus, a DB information request for acquiring DB information of the external apparatus, when the control request receiving unit receives the control request and the external apparatus is able to be remotely controlled or when the change request transmitting unit transmits the change request to the external apparatus and the external apparatus is consequently able to be remotely controlled;
a DB information receiving unit receiving the DB information of the external apparatus transmitted from the external apparatus as a result obtained when the DB information request transmitting unit transmits the DB information request to the external apparatus; and
a DB information transmitting unit transmitting, to the controller, the DB information of the external apparatus received by the DB information receiving unit by network communication.

3. The information processing apparatus according to claim 2, further comprising:
a DB information storage unit storing the DB information of the external apparatus received by the DB information receiving unit.

4. The information processing apparatus according to claim 2, wherein the DB information transmitting unit transmits, to the controller, meta information in the DB information of the external apparatus received by the DB information receiving unit by the network communication.

5. The information processing apparatus according to claim 2,
wherein when the control request receiving unit receives the control request and the external apparatus is able to be remotely controlled or when the change request transmitting unit transmits the change request to the external apparatus and the external apparatus is consequently able to be remotely controlled, the DB information request transmitting unit transmits, to the external apparatus, DB information request for acquiring the meta information in the DB information of the external apparatus,
wherein the DB information receiving unit receives the meta information, which is transmitted from the external apparatus, in the DB information of the external apparatus as a result obtained when the DB information request transmitting unit transmits the DB information request to the external apparatus, and
wherein the DB information transmitting unit transmits the meta information, which is received by the DB information receiving unit, in the DB information of the external apparatus to the controller by the network communication.

6. The information processing apparatus according to claim 5, further comprising:
a DB information storage unit storing the meta information, which is received by the DB information receiving unit, in the DB information of the external apparatus.

7. The information processing apparatus according to claim 1,
wherein the control request is a control request for changing an operation mode of the external apparatus to a remote control enabled mode, and
wherein the change request is a change request for changing the operation mode of the external apparatus to the remote control enabled mode.

8. An information processing method comprising:
receiving, from a controller, a control request for remotely controlling an external apparatus connected to a connection unit by network communication; and
transmitting, to the external apparatus, a change request so that the external apparatus is able to be remotely controlled, when the control request is received in the receiving of the control request and the external apparatus is not able to be remotely controlled.

9. A program causing a computer to function as:
a control request receiving unit receiving, from a controller, a control request for remotely controlling an external apparatus connected to a connection unit by network communication; and
a change request transmitting unit transmitting, to the external apparatus, a change request so that the external apparatus is able to be remotely controlled, when the control request receiving unit receives the control request and the external apparatus is not able to be remotely controlled.

10. An information processing system comprising:
a controller; and
an information processing apparatus,
wherein the controller includes
a control request transmitting unit transmitting, to the information processing apparatus, a control request for remotely controlling an external apparatus connected to the information processing apparatus by network communication, and
wherein the information processing apparatus includes
a connection unit connecting the external apparatus to the information processing apparatus,
a control request receiving unit receiving, from the controller, the control request for remotely controlling the external apparatus by the network communication, and
a change request transmitting unit transmitting, to the external apparatus, a change request so that the external apparatus is able to be remotely controlled, when the control request receiving unit receives the control request and the external apparatus is not able to be remotely controlled.
